(19) United States
(12) Patent Application Publication
(10) Pub. No.: US 2014/0017101 A1
(43) Pub. Date: Jan. 16, 2014

(54) CLUTCH SUBASSEMBLY AND CLUTCHED SUPERCHARGER MADE USING THE SAME

(71) Applicant: Eric D. Staley, Flushing, MI (US)

(72) Inventor: Eric D. Staley, Flushing, MI (US)

(73) Assignee: GM GLOBAL TECHNOLOGY OPERATIONS LLC, Detroit, MI (US)

(21) Appl. No.: 13/545,250

(22) Filed: Jul. 10, 2012

(51) Int. Cl. F16D 11/14; F04D 25/08

(52) U.S. Cl. 417/319; 192/69.71

(57) ABSTRACT

A clutch subassembly for a supercharger is disclosed. The clutch assembly includes a clutch subassembly housing, the clutch subassembly housing having an input shaft end, a supercharger end and a longitudinal axis. The clutch subassembly also includes a clutch input shaft rotatably disposed within the input shaft end. The clutch subassembly further includes a selectively rotatable clutch assembly disposed in the supercharger end, the clutch assembly comprising a rotating portion that is operably coupled to the clutch input shaft and a selectively rotatable portion that is selectively engageable with the rotating portion through a clutch, the selectively rotatable portion comprising a rotatable hub, the rotatable hub having a shaft engagement feature.

### FIELD OF THE INVENTION

The subject invention relates generally to a clutch subassembly, and more particularly a clutch subassembly for a supercharger, and even more particularly to clutch and supercharger assembly.

### BACKGROUND

Accordingly, it is desirable to provide a clutch assembly for a supercharger. Superchargers are used to increase or “boost” the air pressure in the air intake manifold of an internal combustion engine. The supercharger provides an increased horsepower output capability over a normally aspirated engine. A conventional supercharger is generally mechanically driven by the engine, and therefore, may represent a drain on engine horsepower whenever engine “boost” may not be required and/or desired. Selectively engageable/disengageable clutches may be disposed in series between the supercharger input (e.g., a belt driven pulley/input shaft) and the rotors of the supercharger.

Several types of clutch assembly configurations and/or designs have been employed in a commercially acceptable and satisfactory manner; however, they generally have disadvantages associated with each type of the above-referenced clutch assemblies. In a large pulley configuration, for example, the pulley is generally integrated to the rotor, and the pulley is of a large enough diameter so as to fit over a clutch coil that is mounted to the supercharger cover. Because the pulley is integrated to the rotor, the pulley design is dependent on the torque capacity of the clutch. In other words, the pulley diameter must be increased if the torque capacity of the clutch is increased. This results in undesirable packaging requirements because the required pulley diameters are typically too large to be commercially feasible. In addition, a large pulley has high inertia. In a small pulley configuration, the pulley design may not be dependent on the size of the clutch coil. However, the pulley is generally integrated with the clutch armature. Because the clutch armature is fixed to the pulley, the clutch armature is generally rotating at the speed of the pulley even when the clutch is disengaged, and the armature may not be particularly stable at higher speeds. In addition, in some configurations, the bearings may have an increased bearing load, and the absence of relative motion between the inner and outer race of the bearing when the clutch is in an engaged position may put additional stress and/or load on the bearings. This may allow damage (e.g., fretting) to the bearings. The fretting becomes an issue due to the belt loads that must be supported by the stationary bearing. A remote-mount pulley configuration generally has the highest inertia associated with putting the clutch in an engaged position.

In addition, these clutched supercharger designs have generally required an integrated clutch and supercharger design where the clutch is built together with the supercharger. While useful, these designs generally do not provide design and manufacturing flexibility and have not allowed the use of a single clutch mechanism with multiple different superchargers made by different manufacturers, for example. In particular, because of the design dependence of these components as described, it has generally not been possible to attach a clutch designed and manufactured for one supercharger to another supercharger without significant redesign and remanufacturing of various components, such as the housings, shafts, bearings and other components of the clutch and/or the supercharger. It is, therefore, very desirable to provide a clutched supercharger that provides design and manufacturing flexibility of the clutch and supercharger.

### SUMMARY OF THE INVENTION

In one exemplary embodiment of the invention, a clutch subassembly for a supercharger is disclosed. The clutch assembly includes a clutch subassembly housing, the clutch subassembly housing having an input shaft end, a supercharger end and a longitudinal axis. The clutch subassembly also includes a clutch input shaft rotatably disposed within the input shaft end. The clutch subassembly further includes a selectively rotatable clutch assembly disposed in the supercharger end, the clutch assembly comprising a rotating portion that is operably coupled to the clutch input shaft and a selectively rotatable portion that is selectively engageable with the rotating portion through a clutch, the selectively rotatable portion comprising a rotatable hub, the rotatable hub having a shaft engagement feature.

In another exemplary embodiment of the invention, a clutch and supercharger assembly is disclosed. The clutch and supercharger assembly includes a clutch subassembly comprising: a clutch subassembly housing, the clutch subassembly housing having an input shaft end, a supercharger end and a longitudinal axis; a clutch input shaft rotatably disposed within the input shaft end; and a selectively rotatable clutch assembly disposed in the supercharger end, the clutch assembly comprising a rotating portion that is operably coupled to the clutch input shaft and a selectively rotatable portion that is selectively engageable with the rotating portion through a clutch, the selectively rotatable portion comprising a rotatable hub, the rotatable hub having a shaft engagement feature. The clutch and supercharger assembly also including a supercharger assembly comprising: a supercharger, the supercharger comprising: a supercharger housing; a rotatable supercharger rotor rotatably disposed in the supercharger housing; and a rotatable supercharger input shaft operably coupled to the supercharger rotor, the supercharger input shaft having a hub engagement feature on an end away from the rotor.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an embodiment of a clutch and supercharger assembly as disclosed herein;

FIG. 2 is a dis-assembled, cross-sectional perspective view of a clutch subassembly and supercharger subassembly as disclosed herein; and

FIG. 3 is a dis-assembled, cross-sectional perspective view of a clutch subassembly as disclosed herein.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

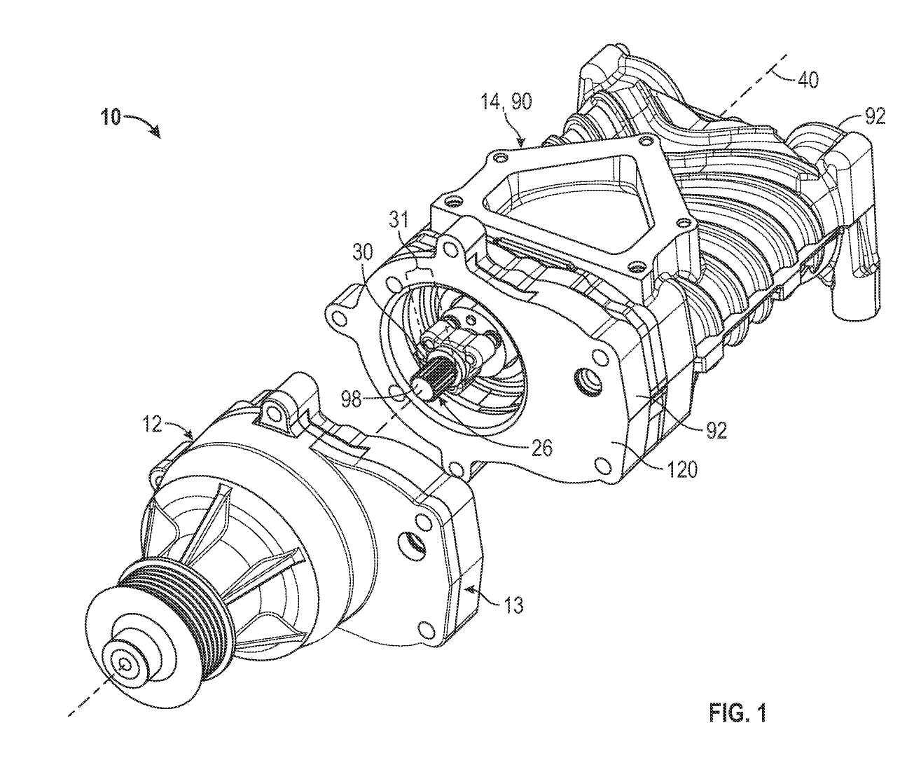

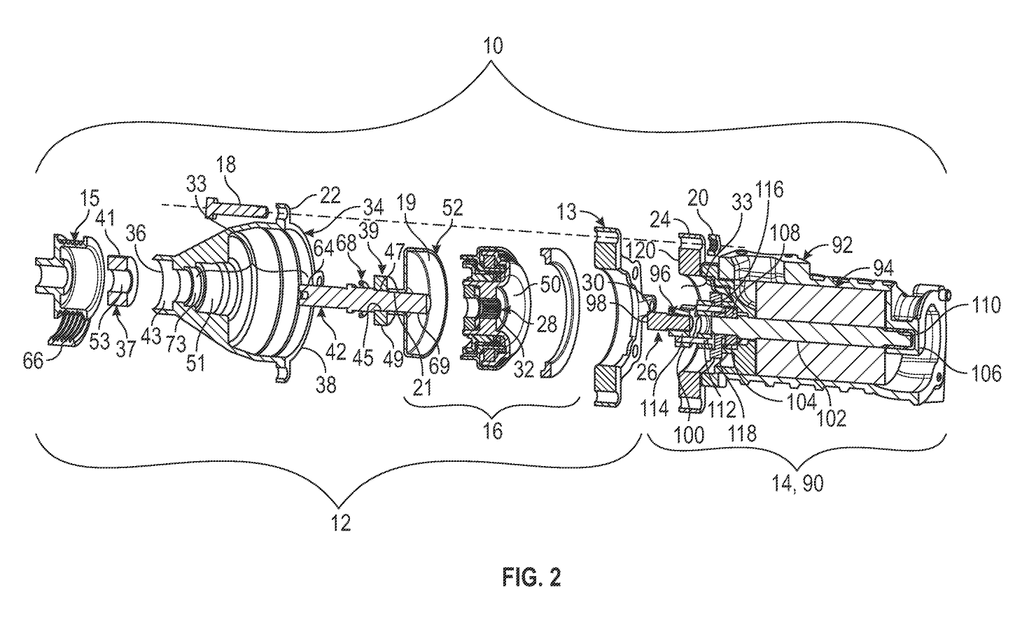

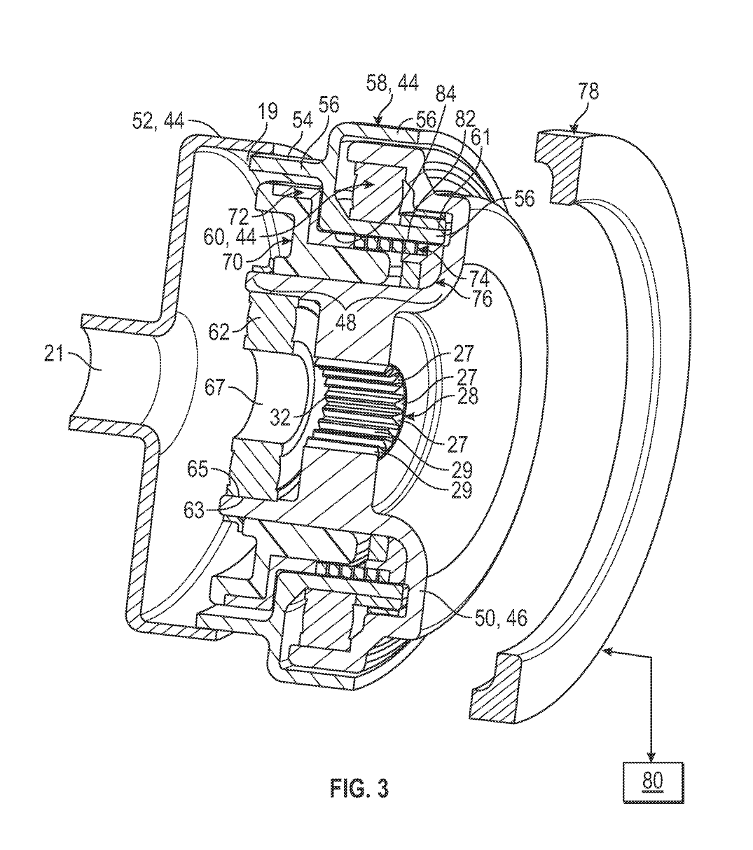

Referring to FIGS. 1-3, in accordance with an exemplary embodiment of the invention, a clutch and supercharger assembly 10 is disclosed that provides a clutched supercharger (i.e., a supercharger that may be selectively engaged and disengaged by operation of a clutch 16) that achieves design and manufacturing flexibility of the clutch subassembly 12 (which may also be referred to as an assembly) and the supercharger subassembly 14 (which may also be referred to as an assembly). For example, the clutch subassembly 12, clutch 16 and supercharger subassembly 14 or supercharger subassemblies 14 may be designed and manufactured separately and integrated through a simple attachment and engagement mechanism. As an example, an attachment mechanism may include bolt-on assembly of the clutch subassembly 12 to the supercharger subassembly 14 using a plurality of threaded bolts 18 and nuts 20, or a threaded bolt 18 and a suitably threaded bore in the clutch housing boss 22 or the supercharger housing boss 24. The engagement mechanism may include engagement of a single mating shaft engagement feature 26 and hub engagement feature 28, including mating engagement of a splined shaft 30 of the supercharger subassembly 14 with a splined bore or hub 32 of the clutch subassembly 12. In one embodiment, the shaft engagement feature 26 includes a splined bore 32 having a plurality of bore splines 27 and the hub engagement feature 28 comprises a plurality of shaft splines 31 corresponding to a plurality of bore recesses 29 disposed between the bore splines 27. The shaft splines 31 are configured for mating engagement with the bore recesses 29, the mating engagement interlocking the selectively rotatable clutch and rotatable rotor such that rotation of the clutch 16 also rotates the rotor 94. The use of a modular clutch subassembly 12 having a hub engagement feature 28, such as a splined hub 32, which may be attached to and operably engaged with any number of suitable supercharger subassemblies 14 through the shaft engagement feature 26, such as a splined shaft 30, is very advantageous because it is possible to quickly and simply configure a single clutch subassembly 12 for operable engagement with multiple supercharger subassemblies 14. Any suitable shaft engagement feature 26 or features and hub engagement feature 28 or features may be employed. This may be used advantageously for purposes of design, prototyping, testing and manufacturing, for example. This arrangement also facilitates enhanced repairability and replacement of the clutch subassembly 12 and/or the supercharger subassembly 14 over the operating lifetime of a vehicle in which the clutch 16 and supercharger assembly 10 has been installed. Further, the clutch subassembly 12 disclosed herein may be very compact, including an overall longitudinal length of about 5-6 inches and a maximum outer diameter or peripheral distance of about 4-5 inches.

Referring again to FIGS. 1-3, the clutch and supercharger assembly 10 includes a clutch subassembly 12 and supercharger subassembly 14. The clutch subassembly includes a clutch subassembly housing 34. The clutch subassembly housing 34 has an input shaft end 36, a supercharger end 38 and a longitudinal axis 40. In one embodiment, the clutch subassembly housing 34 includes a frustoconical housing opening radially outwardly toward the supercharger end 38. The clutch subassembly housing 34 may be formed from any suitable material, including various metals, such as, for example, aluminum and aluminum alloys. The clutch subassembly 12 also includes a clutch input shaft 42 rotatably disposed within the input shaft end 36 on a first or outer bearing 37 and a second or inner bearing 39. The clutch input shaft 42 may be formed from any suitable material, including various metals, such as, for example, various grades of steel, as well as aluminum and aluminum alloys. The outer bearing 37 may be press-fit on an outer surface 41 into an outer bearing pocket 43. The inner diameter 45 of the inner bearing 39 may be press-fit onto the outer surface 47 of clutch input shaft 42 and the outer surface 49 of the inner bearing 39 and clutch input shaft 42 may be press-fit into an inner bearing pocket 51, while the outer surface 47 of the clutch input shaft 42 is simultaneously press-fit into the inner surface 53 of outer bearing 37 leaving the clutch input shaft 42 rotatably disposed on outer bearing 37 and inner bearing 39.

The clutch subassembly 12 further includes a selectively rotatable clutch 16 comprising an assembly of components as described herein disposed in the supercharger end 38. The clutch 16 includes a rotating portion 44 that is operably coupled to the clutch input shaft 42 and a selectively rotatable portion 46 that is selectively engageable with the rotating portion 44 through the clutch mechanism 48.

The rotating portion 44 includes a carrier housing 52, carrier 58 and carrier bearing 60. The carrier housing 52 is attached to the outer surface 47 of clutch input shaft 42 through carrier housing bore 21, such as by being press-fit onto the shaft, and is configured to receive and be attached on a rim 19 to a rib 54 of a U-shaped section 56 of carrier 58, such as by press-fit engagement. The carrier housing 52 and carrier 58 may be formed from any suitable material, including various metals, such as, for example, aluminum and aluminum alloys. The carrier 58 has a carrier bearing 60 that facilitates relative rotation of the rotating portion 44 and the rotatable hub 50 of selectively rotatable portion 46 when the clutch mechanism 48 is disengaged. The carrier bearing 60 may be attached to, such as by being press-fit onto, an inner leg 61 of the U-shaped section 56.

The selectively rotatable portion 46 includes a rotatable hub 50, a hub bearing 62 and the clutch mechanism 48. The rotatable hub 50 may be formed from any suitable material, including various metals, such as, for example, various grades of steel, as well as aluminum and aluminum alloys. The outer surface 63 of the hub bearing 62 is attached, such as by being press-fit, within the hub bearing pocket 65. The inner surface 67 of the hub bearing 62 is configured to receive a clutch end 69 of the clutch input shaft 42. The hub bearing 62 captures the clutch end 69 of the clutch input shaft 42 and maintains concentric rotation of the end when the shaft is rotating, whether the selectively rotatable portion 46 is rotating or not. This construction using hub bearing 62 is very advantageous because it maintains the concentric rotation of the shaft along the longitudinal axis while the other end 64 of the clutch input shaft 42 is subjected to variable torque loads and bending moments as it is driven by a drive or auxiliary belt 66 and rotatable drive pulley 15 located proximate the input shaft end 36. The hub bearing 62 also acts to minimize radial runout and imbalance of the rotating clutch assembly 12.

The clutch mechanism 48 may include any suitable clutch mechanism, including various mechanical and electromechanical clutch mechanisms. In one embodiment, the selectively rotatable portion 46 of the clutch 16 also includes an electromagnetically activatable clutch mechanism 48 that includes a spring actuator 70 that is operably coupled to an armature 72 and a wrap or coil spring 74, which is in turn attached to a spring retainer 76. The clutch mechanism 48 also includes an electromagnetic coil 78 that is in power and signal communication with a controller 80, such as an engine controller, for selective application of a direct current to the windings of the coil 78 to energize the coil and provide an electromagnetic flux within the components of the clutch subassembly 12 and clutch mechanism 48. When the coil 78 is energized, the spring actuator 70 and armature 72, which may be formed as a single component, compress the coil spring 74 against the spring retainer 76. This causes the diameter of the coil spring 74 to increase, thereby causing the outer surface 82 of the coil spring to pressingly engage and mechanically interlock the inner surface 84 of the inner leg 71 of the U-shaped section 56 of carrier 58, such that the selectively rotatable portion 46 of the clutch 16 rotates together with the rotating portion 44 and the clutch mechanism 48 is in an engaged position. In this way, the coil spring 74 is selectively moveable from an expanded position of the spring where the clutch 16 is disengaged to a compressed position of the spring where the outer surface 82 of the spring is engaged against the carrier 58 and the clutch 16 is engaged thereby mechanically coupling the rotatable hub 50 to the carrier 58.

The clutch subassembly 12 also may include a lip seal 68 that is configured to seal on the outer surface 47 of the clutch input shaft 42 and an inner surface 73 of the clutch housing 34 to enable clutch 16 to be immersed in a liquid lubricant and coolant (not shown) such as oil. The lip seal 68 may be formed from any suitable material, including various polymers and elastomers, such as polytetrafluoroethylene (PTFE). The lip seal 68 is disposed on the clutch input shaft between the first shaft bearing 37 and the second shaft bearing 39 and sealably disposed between the clutch input shaft 42 and the clutch subassembly housing 34. The lip seal 68 and clutch subassembly housing 34 together define a lubricant reservoir 33 within the clutch subassembly housing 34 between the lip seal 68 and the supercharger end 38 of the housing, wherein the selectively rotatable clutch assembly 16 is disposed within the lubricant reservoir 33 and configured for lubrication by a lubricant (not shown) disposed therein.

In one embodiment, the clutch subassembly 12 may also include a clutch assembly housing extension 13. The clutch assembly housing extension 13 is configured for attachment to and enclosure of the supercharger end 38 of the clutch assembly housing 34 and a clutch end 120 of the supercharger housing 92. Since the hub engagement feature 28, such as a splined shaft 30, may protrude from the clutch end 120 of the supercharger housing 92, or the shaft engagement feature 26, such as a splined hub 32, may be recessed within the clutch subassembly housing 34, or a combination thereof, it may be desirable to use a clutch assembly housing extension 13 to bridge space between them. The use of a clutch assembly housing extension 13 may be particularly useful when adapting several different supercharger subassemblies 14 having different hub engagement features 28 that protrude by different amounts to engage the clutch subassembly 12. These extensions may be easily machined to fit the supercharger end 38 of the clutch assembly housing 34 and a clutch end 120 of the supercharger housing 92 and provide any predetermined axial length sufficient to bridge the space between them, if needed. The clutch assembly housing extension 13 may be formed from any suitable material, and in one embodiment may include aluminum or an aluminum alloy.

The clutch and supercharger assembly 10 also includes a supercharger subassembly 14. The supercharger subassembly 14 includes a supercharger 90. The supercharger 90 includes: a supercharger housing 92; a rotatable supercharger rotor 94 that is rotatably disposed in the supercharger housing 92; and a rotatable supercharger input shaft 96 that is operably coupled to the supercharger rotor 94. The supercharger input shaft 96 has a hub engagement feature 28 on an end 98 away from the rotor 94. The supercharger subassembly 14 is characterized by the hub engagement feature 28, such as a splined shaft 30, which may include a splined portion of the supercharger input shaft 96. The supercharger housing 92 may be formed from a suitable material, including various metals, such as aluminum and aluminum alloys. The rotatable supercharger input shaft 96 may be operably coupled to the supercharger rotor 94 through a coupler 100 that provides a compliant mechanical coupling to the rotor 94 and the rotatable rotor shaft 102 to which it is attached. Coupler 100 may include a plurality of pins 112 extending between and coupling together a first portion 114 that is attached to the supercharger input shaft 96 and a second portion 116 that is attached to the rotor shaft 102. The rotor shaft 102 is rotatably disposed within and supported by a first rotor bearing 104 and a second rotor bearing 106 that are disposed in first bearing pocket 108 and second bearing pocket 110 formed in the supercharger housing 92. A portion of the lubricant reservoir 33 is also defined within the supercharger housing 92 and encompasses the coupler 100 between the supercharger input shaft 96 and the rotor shaft 102 and a drive gear 118 disposed on the rotor shaft 102.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A clutch subassembly for a supercharger, comprising:
a clutch subassembly housing, the clutch subassembly housing having an input shaft end, a supercharger end and a longitudinal axis,
a clutch input shaft rotatably disposed within the input shaft end; and
a selectively rotatable clutch assembly disposed in the supercharger end, the clutch assembly comprising a rotating portion that is operably coupled to the clutch input shaft and a selectively rotatable portion that is selectively engageable with the rotating portion through a clutch, the selectively rotatable portion comprising a rotatable hub, the rotatable hub having a shaft engagement feature.

2. The clutch subassembly of claim 1, wherein the clutch subassembly is entirely housed within the clutch subassembly housing and configured for bolt-on attachment to a supercharger housing of a supercharger subassembly and operable engagement with the supercharger solely through mating engagement of a supercharger input shaft with the shaft engagement feature.

3. The clutch subassembly of claim 1, wherein the shaft engagement feature comprises a splined bore.

4. The clutch subassembly of claim 1, further comprising a rotatable drive pulley located proximate the input shaft end that is operably coupled to the input shaft.

5. The clutch subassembly of claim 1, further comprising a first shaft bearing that is disposed on an outer surface in a first bearing pocket opening to the input shaft end and a second shaft bearing that disposed on an outer surface in a second bearing pocket opening to the supercharger end, an inner surface of the first bearing and an inner surface of the second bearing pressed onto an outer surface of the clutch input shaft and rotatably supporting the clutch input shaft along the longitudinal axis of the clutch subassembly housing.

6. The clutch subassembly of claim 1, further comprising a third bearing that is attached on an outer surface to the selectively rotatable portion of the clutch, and on an inner surface provides rotatable support to an end of the clutch input shaft proximate the clutch.

7. The clutch subassembly of claim 1, further comprising a fourth bearing disposed on one of the rotatable portion or the selectively rotatable portion of the clutch and rotatably supporting the selectively rotatable portion of the clutch.

8. The clutch subassembly of claim 1, wherein the clutch is an electromagnetically activatable coil spring clutch.

9. The clutch subassembly of claim 1, wherein the clutch comprises an electromagnet coil disposed on a carrier of the selectively rotatable portion and an armature that is operably disposed on a spring actuator, the armature and spring actuator disposed on the rotatable hub in operable engagement with a coil spring, wherein the coil spring is selectively moveable from an expanded position of the spring where the clutch is disengaged to a compressed position of the spring where the outer surface of the spring is engaged against the carrier and the clutch is engaged thereby mechanically coupling the rotatable hub to the carrier.

10. The clutch subassembly of claim 1, wherein the clutch subassembly housing comprises a frustoconical housing opening radially outwardly toward the supercharger end.

11. The clutch subassembly of claim 1, further comprising a clutch assembly housing extension.

12. The clutch subassembly of claim 11, wherein the clutch assembly housing extension is configured for attachment to and enclosure of the supercharger end of the clutch assembly housing and a clutch end of a supercharger housing.

13. A clutch and supercharger assembly, comprising:
a clutch subassembly comprising:
a clutch subassembly housing, the clutch subassembly housing having an input shaft end, a supercharger end and a longitudinal axis,
a clutch input shaft rotatably disposed within the input shaft end; and
a selectively rotatable clutch assembly disposed in the supercharger end, the clutch assembly comprising a rotating portion that is operably coupled to the clutch input shaft and a selectively rotatable portion that is selectively engageable with the rotating portion through a clutch, the selectively rotatable portion comprising a rotatable hub, the rotatable hub having a shaft engagement feature; and
a supercharger assembly comprising a supercharger, the supercharger comprising:
a supercharger housing;
a rotatable supercharger rotor rotatably disposed in the supercharger housing; and
a rotatable supercharger input shaft operably coupled to the supercharger rotor, the supercharger input shaft having a hub engagement feature on an end away from the rotor.

14. The clutch and supercharger assembly of claim 13, wherein the shaft engagement feature comprises a splined bore having a plurality of bore splines and the hub engagement feature comprises a plurality of shaft splines corresponding to a plurality of bore recesses disposed between the bore splines, and wherein the shaft splines are configured for mating engagement with the bore recesses, the mating engagement interlocking the selectively rotatable clutch and rotatable rotor such that rotation of the clutch also rotates the rotor.

15. The clutch and supercharger assembly of claim 13, further comprising a rotatable drive pulley located proximate the input shaft end that is operably coupled to the input shaft.

16. The clutch and supercharger assembly of claim 13, further comprising a first shaft bearing that is disposed on an outer surface in a first bearing pocket opening to the input shaft end and a second shaft bearing that disposed on an outer surface in a second bearing pocket opening to the supercharger end, an inner surface of the first bearing and an inner surface of the second bearing pressed onto an outer surface of the clutch input shaft and rotatably supporting the clutch input shaft along the longitudinal axis of the clutch subassembly housing.

17. The clutch and supercharger assembly of claim 13, further comprising a third bearing that is attached on an outer surface to the selectively rotatable portion of the clutch, and on an inner surface provides rotatable support to an end of the clutch input shaft proximate the clutch.

18. The clutch and supercharger assembly of claim 13, further comprising a fourth bearing disposed on one of the rotatable portion or the selectively rotatable portion of the clutch and rotatably supporting the selectively rotatable portion of the clutch.

19. The clutch and supercharger assembly of claim 13, wherein the clutch is an electromagnetically activatable coil spring clutch.

20. The clutch and supercharger assembly of claim 20, further comprising a clutch assembly housing extension configured for attachment to and enclosure of the supercharger end of the clutch assembly housing and a clutch end of a supercharger housing.

21. The clutch and supercharger assembly of claim 16, further comprising a lip seal disposed on the clutch input shaft between the first shaft bearing and the second shaft bearing , the lip sealably disposed between the clutch input shaft and the clutch subassembly housing, the lip seal defining a lubricant reservoir within the clutch subassembly housing between the lip seal and the supercharger end of the housing, wherein the selectively rotatable clutch assembly is disposed within the lubricant reservoir and configured for lubrication by a lubricant disposed therein.

22. The clutch and supercharger assembly of claim 21, wherein the lubricant reservoir is also defined within the supercharger housing and encompasses a coupling between the supercharger input shaft and a rotor shaft and a drive gear disposed on the rotor shaft.
